(19) United States
(12) Patent Application Publication
(10) Pub. No.: US 2020/0307066 A1
(43) Pub. Date: Oct. 1, 2020

(54) METHOD FOR COATING A SURFACE USING A PROFILED COATING MATERIAL AND A COATING MATERIAL

(71) Applicant: HOMAG GmbH, Schopfloch (DE)

(72) Inventor: Felix SCHATZ, Dornhan (DE)

(21) Appl. No.: 16/635,143

(22) PCT Filed: Aug. 1, 2018
(86) PCT No.: PCT/EP2018/070858

§ 371 Date: Jan. 29, 2020

(30) Foreign Application Priority Data
Aug. 4, 2017 (DE) 10 2017117 714.0

(51) Int. Cl. B29C 63/00; B27D 5/00

(52) U.S. Cl. CPC B29C 63/003; B29C 63/0065; B27D 5/003

(57) ABSTRACT

The present invention relates to a method and a coating material (10) for coating a surface, particularly a narrow side of a plate-shaped workpiece (W), which preferably consists, at least in part, of wood, wood materials, wood substitute materials, plastic or the like, said method comprising the following steps: supplying a coating material (10), wherein the coating material (10) has a recess (10a) extending in a longitudinal direction of the coating material (10), and; applying the coating material (10) to at least one surface (W1) of a workpiece (W) to be coated, wherein the workpiece (W) has, on the at least one surface (W1) to be coated, a profile (P), which is complementary at least in part to the recess (10a).

### TECHNICAL FIELD

The present invention relates to a method for coating a surface, in particular a narrow side of a plate-shaped workpiece which preferably consists, at least in part, of wood, wood-based materials, wood substitute materials, plastics material or the like, and also to a coating material. Such a method or coating material is used in the field of the furniture or components industry, for example.

### PRIOR ART

Providing a strip-shaped or band-shaped coating material with an adhesive and applying it to a narrow side of a workpiece, for example, is known from the prior art. Usually, a coating material with a rectangular cross section is used for this.

In the edge region of the workpiece thereby produced, a suitable end to the coating material is obtained in the form of a radius or a chamfer. In the case of a coating material having a thickness of 3 mm, for example, a radius of 3 mm is obtained in the edge region, or a chamfer with a width of 3 mm. The edge region described contributes significantly to the value of the coated workpiece. In particular, the visual appearance, the geometry and the quality of the coated workpiece are impacted by this measure.

The region in the central position of the coating material, i.e. the region of the coating material in the thickness direction of the workpiece to be coated, does not have a function. On the contrary, on account of the consistently rectangular profile of the coating material, the cost of the coating material is higher owing to the increased amount of material used, and the flexibility of the coating material is lower.

Furthermore, when producing such narrow surface coatings the transition between the coating material and the surface of the main side of the workpiece is a problem. It generally creates a joint at which the adhesion of the coating material to the narrow side fails, such that a narrow space is created between the workpiece and the coating material. Thus, starting at the joint the coating tends over time to slowly peel off inwardly from the coated surface.

### THE SUBJECT MATTER OF THE INVENTION

The object of the present invention is to provide a method for coating surfaces and a coating material for coating, in particular, narrow sides of plate-shaped workpieces in an efficient and high-quality manner, in particular using a reduced amount of coating material.

The object is achieved by a method as according to claim 1 and a coating material as according to claim 11. Preferred embodiments of the invention are described in the dependent claims, wherein the subject matter of the dependent claims relating to the coating material can be used within the scope of the method, and vice versa.

One of the central ideas of the present invention is to provide a method for coating a surface, in particular a narrow side of a plate-shaped workpiece, as well as a coating material for this, with which the amount of coating material used can be minimized without reducing the aesthetic and haptic value of the coating. This is achieved by the coating material being provided with a recess, in particular a recess in the central region of the coating material, as a result of which the amount of coating material used can be reduced, and by the surface to be coated of the workpiece to be coated being provided with a profile which is complementary, at least in part, to this recess.

Using the method proposed and the coating material provided, it is possible in a simple and efficient manner to reduce the amount of material used for the production of the coating material and at the same time to at least maintain the aesthetic and haptic value and give the impression of a wide edge.

According to the present invention, the method for coating a surface, in particular a narrow side of a plate-shaped workpiece which preferably consists, at least in part, of wood, wood-based materials, wood substitute materials, plastics material or the like, comprises the steps of: supplying a coating material, wherein the coating material has a recess extending in the longitudinal direction of the coating material, and applying the coating material to at least one surface of a workpiece to be coated (wherein the recess faces the workpiece), wherein the workpiece has, on the at least one surface to be coated, a profile which is complementary at least in part to the recess.

The method described within the scope of the present invention can be used both in the field of stationary technology and in the field of throughfeed technology. The workpieces to be machined are, in particular, plate-shaped, and have one or more edges or corners, for example, and therefore a varying surface, as in the case of a door rebate.

In the field of stationary technology, a workpiece is held using suction clamps or clamping devices, for example, and a coating unit is moved relative to the held workpiece with a pressure roller or pressure shoe. In the case of a throughfeed method, however, the workpiece is moved relative to a coating unit.

Within the scope of the present invention, the term “recess” is to be understood such that the coating material has a profile, in particular a transverse profile or cross section, such that the side of the coating material that later comes into contact with the workpiece to be coated has a region having a smaller thickness than the original thickness of the coating material. In other words, the coating material has a recess, or a region of weakness, extending along the length of the coating material, in particular in a continuous manner.

Using the method proposed, it is possible in a simple and efficient manner to reduce the amount of material used for the production of the coating material and at the same time to achieve aesthetic and haptic value for the coating, as with known coating methods with conventional coating materials. Owing to the recess provided, the amount of material used for the production of the coating material can be reduced by the volume of the recess. This in turn has a beneficial effect on the cost of production of the coating material.

According to one embodiment of the present invention, the method further comprises: a machining process, by means of which the profile of the workpiece is formed, wherein the machining process is preferably carried out using a milling tool, a scraping tool and/or an abrasive belt.

In this way, it is possible using simple tools to provide the workpiece with a profile which is complementary at least in part to the recess in the coating material.

Furthermore, it is preferred that the profile is formed on the at least one surface to be coated of the workpiece while the workpiece is supplied and/or while the coating material is applied to the workpiece and/or that it has already been formed thereon in a previous work step.

Thus, the process of producing the profile of the workpiece, which is complementary at least in part, can be integrated into the coating process of the workpiece, i.e. the profile can be produced by way of joint cutting, for example. This offers the advantage that, for example, when milling the profile the manufacturing tolerances of the recess in the coating material can be adapted.

According to a preferred embodiment of the present invention, scanning is performed on the workpiece to be coated, in particular thickness scanning and/or contour scanning, while the profile is formed on the at least one surface to be coated of the workpiece. This offers the advantage that any tolerances of the workpiece contour can be taken into consideration when the profile is produced, in order to be able to ensure that the profile has the desired dimensions so as to be able to be reliably inserted into the recess in the coating material. Moreover, there is also the possibility of changing the position of the profile in the thickness direction of the workpiece in order to compensate for any tolerances, in particular thickness tolerances, of the workpiece. This is to be understood to the effect that if the thickness of the workpiece exceeds a certain tolerance range, and therefore it is not possible for the available coating material to cover the narrow side of the workpiece in its entirety, the position of the profile is moved such that at least one edge of the workpiece is clean, i.e. is coated evenly. This edge is preferably a visible edge. In the case of a table top, for example, it is the edge that is later turned upward, i.e. in direct view.

Furthermore, it is preferable that the recess extending in the longitudinal direction of the coating material is formed while the coating material is produced.

It is also preferred that the recess in the coating material is formed by way of machining during the extrusion of the coating material, in particular during the co-extrusion of the supporting layer and the adhesive layer, and/or after the extrusion of the coating material.

The provision of the recess is particularly advantageous in the case of coating materials made of plastics material, since in this case the coating material can be extruded in the final form thereof, i.e. with the recess. In this way there is no need to subsequently produce the recess and the amount of material used can be directly reduced.

However, there is also the possibility of machining the coating material after the extrusion in order to produce the recess or the profile form.

In a further embodiment of the method according to the invention, the profile, in particular a trapezoidal protrusion that is complementary at least in part in particular to the recess in the coating material, is milled on the at least one surface to be coated using at least one profile milling tool, preferably two profile milling tools, while the workpiece to be coated is supplied.

Furthermore, it is advantageous if an adhesive/functional layer is applied at least in sections to the surface to be coated of the workpiece and/or to the surface of the coating material that is provided with the recess, wherein the adhesive/functional layer is preferably applied to the coating material by means of aftercoating (“offline gluing”) while the coating material is produced and/or it is subsequently applied to the profiled coating material and/or the profiled workpiece.

Moreover, it is preferable if with this method the activation of an adhesive layer of the coating material is carried out during a relative movement between the coating material and the workpiece, preferably immediately before the actual coating process, wherein the activation is carried out by way of an energy source selected in particular from a laser, a hot air source or a gassing source, an infrared source, an ultrasound source, a magnetic field source, a microwave source, a plasma source and/or an LED source. In this regard it is also possible to use several of the energy sources mentioned in combination with one another.

The laser makes it possible to focus particularly quickly on a certain area of the coating material. Thus, energy can be provided particularly quickly with a laser, as a result of which high operating speeds are facilitated. A hot air source, for example, is available comparatively cheaply and requires a relatively low amount of maintenance.

According to a further embodiment of the method according to the present invention, a connecting corner of the workpiece is coated using two coating materials, in particular using a longitudinal coating and a transverse coating, wherein the connecting corner has a longitudinal side and a transverse side, which are preferably disposed at right angles to one another, the two coating materials have a complementary chamfer in the connecting corner of the workpiece such that they abut against one another without raising the profile, and the depth of the recesses in the two coating materials is preferably selected such that the coating materials completely surround the workpiece at the connecting corner thereof. This means that the depth of the recesses in the two coating materials, which is generally the same, is selected such that it is smaller than a miter radius of the two coating materials.

In this way, it can be ensured that the two coating materials completely surround the corner of the workpiece. As a consequence, a connecting corner giving an impression of high quality can be created.

Moreover, the present invention relates to a coating material, in particular a narrow surface coating material or edging material, for coating surfaces of a workpiece, in particular for coating varying surfaces of a workpiece which preferably consists, at least in sections, of wood, wood-based materials, wood substitute materials, plastics material or the like, comprising: a supporting layer having a first surface, which is designed to be applied to at least one surface of a workpiece to be coated, and a recess extending in the longitudinal direction of the coating material, wherein the recess is provided in the first surface.

Within the meaning of the present invention, a varying surface refers for example to surfaces composed of various workpiece sides which, in particular, are angled and/or merge into one another via one or more radiuses. Examples of varying surfaces include a corner or an edge of an in particular plate-shaped workpiece. In particular, a narrow side may comprise a corner and/or an edge. Such surfaces are present in the region of a door rebate, for example.

Using the coating material provided, it is possible in a simple and efficient manner to reduce the amount of material used in the production of the coating material and at the same time to achieve aesthetic and haptic value for the coating, as in the case of known coating materials. Moreover, owing to the provision of the recess and the associated weakening of the transverse profile of the coating material, the flexibility or elasticity of the coating material can be increased, which makes it possible to coat workpieces with smaller radiuses. In other words, as compared with conventional coating materials, equal radiuses on a workpiece to be coated can be coated with thicker coating materials, which contributes to improving the appearance and quality of the end product.

Furthermore, it is preferred that when the coating material is viewed in cross section, the recess is formed in a trapezoidal shape, a U shape, a V shape or a W shape and/or from a combination of chamfers, straight lines and arcs, wherein the recess preferably has an equal-sided trapezoidal form with a longer base side on the outer side of the coating material.

It is also advantageous if the recess is positioned and formed such that the longest dimension of the recess, which in the case of a recess with an equal-sided trapezoidal form is the longer base side of the equal-sided trapezoid, touches the two longitudinal side walls of the coating material, or is a specified distance from the two longitudinal side walls.

Moreover, it is preferred that the depth of the recess is selected such that the depth is smaller than a miter radius or a miter angle at at least one end of the coating material.

In this way, it can be ensured that one corner of the workpiece is completely surrounded by the coating material.

According to a further embodiment of the present invention, the coating material comprises an activatable or reactivatable adhesive layer.

It is also preferred that the coating material is an extruded coating material, in particular a co-extruded coating material, wherein in particular the supporting layer and the adhesive layer are co-extruded, or the supporting layer of the coating material is provided with an adhesive layer following the production thereof, wherein the adhesive layer is preferably applied using nozzles or profiled paste rollers.

It is also advantageous if the supporting layer of the coating material is formed at least in sections of PVC, polystyrene, in particular of ABS, of PP, PE, polycarbonate and/or polymethylmethacrylate (PMMA), as HPL, CPL, melamine paper and/or as a veneer.

According to a further embodiment of the present invention, the coating material has a thickness of between 0.5 mm and 4 mm, preferably between 0.7 mm and 4 mm, more preferably between 1.5 mm and 4 mm, wherein the adhesive layer in particular has a thickness of 0.1 mm to 0.3 mm and the recess preferably has a depth of 0.1 mm to 3 mm, preferably of 0.5 mm to 3 mm.

Thus, on account of the recess coating materials with comparably large thicknesses can also be used, since in spite of the large thickness of the coating material, the amount of material used can be kept to a minimum, and the flexibility of the coating material in relation to the thickness of the material can be improved as compared with known coating materials.

Furthermore, it is preferred that the depth of the recess in the coating material is greater than 60% of the thickness of the coating material, preferably greater than 70% of the thickness of the coating material.

It is also advantageous if the width of the recess, when viewed in the width direction of the coating material, is greater than 70% of the width of the coating material, preferably greater than 80% of the width of the coating material, more preferably greater than 90% of the width of the coating material, wherein sufficient coating material preferably remains at the two edges of the coating material to be able to provide an end radius or end chamfer on the contiguous surface of the workpiece.

In this way it is possible to maximize the amount of material that can be saved owing to the recess, and also to adjust the flexibility of the coating material in an optimum manner.

Moreover, it is preferred that the adhesive layer of the coating material has color pigments, in particular color pigments in the color of the supporting layer and/or the coating of the workpiece to be coated.

In this way, it is possible to adapt the coloring of the adhesive layer to that of the supporting layer. Thus, once the coating material has been applied to a workpiece, the adhesive layer is imperceptible, or is barely perceptible, without reducing the thickness of the adhesive layer.

### BRIEF DESCRIPTION OF THE DRAWINGS

FIG. 1 schematically shows a workpiece which has been coated in accordance with a coating method as according to a first embodiment of the present invention,

FIG. 2 schematically shows a workpiece which has been coated in accordance with a coating method as according to a second embodiment of the present invention,

FIG. 3 schematically shows a workpiece which has been coated in accordance with the coating method as shown in FIG. 2, wherein the coating material has rounded edges,

FIG. 4 shows an exploded view of the coated workpiece of FIG. 2,

FIG. 5 shows a coating material for the coating method shown in FIG. 2,

FIG. 6 schematically shows a connecting corner of a workpiece which has been coated in accordance with the coating method shown in FIG. 2, and

FIG. 7 schematically shows a spatial representation of a connecting corner of a workpiece which has been coated in accordance with the coating method shown in FIG. 3.

### DETAILED DESCRIPTION OF THE PREFERRED EMBODIMENTS

In the following, preferred embodiments of the present invention will be described in detail on the basis of the enclosed drawings. Further modifications cited in this context of certain features can each individually be combined in order to form further embodiments.

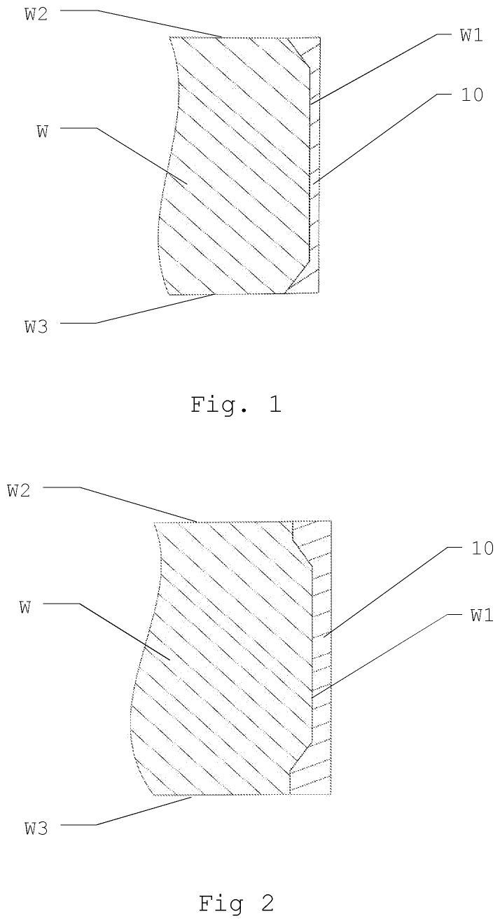

FIG. 1 schematically shows a workpiece W which has been coated in accordance with a coating method as according to a first embodiment of the present invention. In particular, FIG. 1 shows a cross-sectional view which intersects the workpiece W and a coating material 10 orthogonally with respect to the longitudinal extension of the coating material 10. As can be derived from FIG. 1, the coating material 10 has a recess 10a on the side facing the workpiece W. This will be addressed in detail later on with respect to FIG. 4. As can also be derived from FIG. 1, the workpiece W that has been coated with the coating material 10 has a profile P which corresponds to the contour of the recess 10a in the coating material, i.e. the profile P of the workpiece W is complementary at least in part to the recess 10a in the coating material 10. As is also revealed by FIG. 1, the recess 10a in the coating material extends as far as the two cover sides (upper side and underside) W2 and W3 of the workpiece W. As a consequence of the fact that the coating material (edging material) is always higher than the workpiece W, for the time being the recess 10a in the coating material protrudes beyond the upper side and underside W2, W3 of the workpiece W. The overhang can be used to compensate for any variations in the thickness of the workpiece. The remaining overhang is preferably removed in a form-fitting manner with respect to the workpiece W by way of a finishing process. FIG. 1 therefore shows the coated workpiece W after finishing. Since the recess 10a in the coating material extends as far as the two cover sides W2, W3 of the workpiece, when forming the profile P of the workpiece W it is only necessary to provide the workpiece W with two chamfers. As can be derived from FIG. 1, the applied coating material 10 gives the impression of a considerably wider edge than the actual width of most of the coating material 10. Thus, the coating material 10 provided can convey the usual impression of high quality, and yet the amount of material used can be drastically reduced.

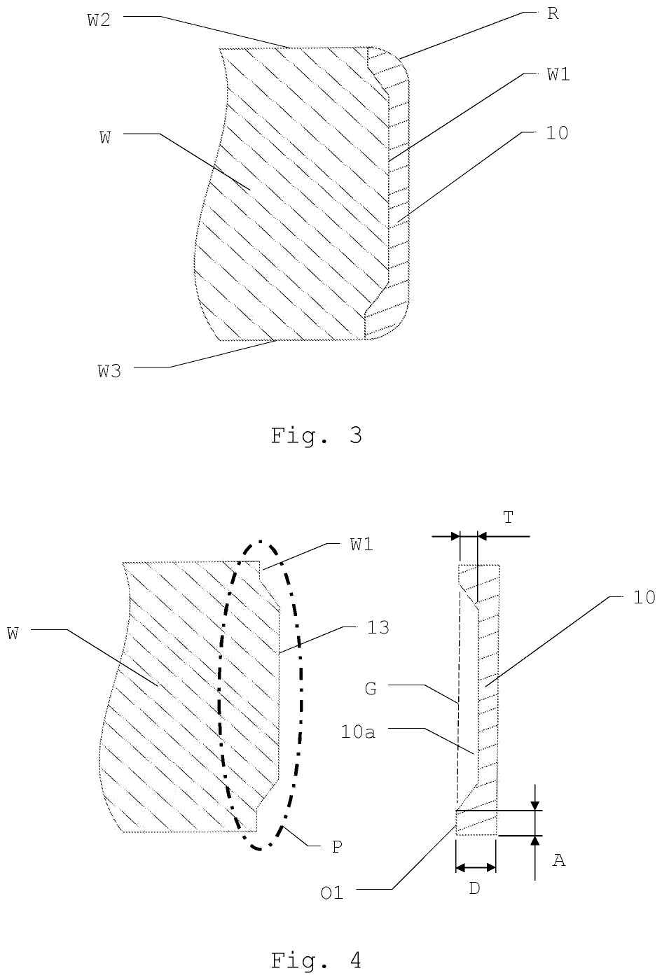

FIG. 2 schematically shows a workpiece which has been coated in accordance with a coating method as according to a second embodiment of the present invention, wherein, in contrast to the embodiment shown in FIG. 1, the recess 10a in the coating material 10 does not extend as far as the two cover sides W2, W3 of the workpiece W. This means that the recess 10a does not extend to the outer longitudinal sides of the coating material 10. Accordingly, the design of the profile P of the workpiece W is more complicated. However, such a configuration of the recess 10a in the coating material 10 offers the advantage that the longitudinal edges of the coating material, which are arranged outwardly following the application of the coating material, are thicker, i.e. they comprise more material, and therefore they are more robust in the face of an external influence or damage.

This configuration is particularly advantageous if, as shown in FIG. 3, the longitudinal edges of the coating material 10, which are arranged outwardly once applied to the workpiece W, are provided with a radius R or with a chamfer. The reason for this is that the edge region of the coating material 10 has to have a sufficient thickness in order for a radius R or a chamfer to be provided, so as not to run the risk of the coating material 10 being too unstable.

In this regard the coating material 10 may already have a radius R or chamfer on the decorative side, i.e. on the side opposite the coating side, before the coating material 10 is applied to the workpiece, which has the advantage that the only finishing required can be carried out using a scraper.

The radius R may taper off tangentially to the workpiece thickness, as shown in FIG. 3. In other words, the transition of the workpiece W leads tangentially to the radius R of the coating material 10. If the coating material 10 on the upper side is 3 mm wide, for example, it is advantageous if it also has a radius R of 3 mm which is milled, for example. This realizes the advantage that a coating material 10 that is thinner per se gives the impression of a thicker edge and therefore also a larger radius R in the edge region.

As can also be derived from FIG. 3, the profile P of the workpiece W extends perpendicularly to the cover sides W2, W3 of the workpiece W at the edges thereof, which results in the advantage that in the case of a varying thickness of the workpiece W the width of the resulting coating remains constant. However, in the case of the embodiment shown in FIG. 1, the width of the coating varies when the thickness of the workpiece varies, since the coating material 10 has to be removed to a greater or lesser extent in accordance with the thickness of the workpiece W and as a result the width of the coating material 10 changes owing to the recess 10a extending at an incline.

Moreover, on account of the vertical joining surface between the coating material 10 and the workpiece W the embodiments shown in FIG. 2 and FIG. 3 offer the advantage that the glued joint or invisible joint is narrower than in the embodiment shown in FIG. 1. The reason for this is that the width of the glued joint or invisible joint increases as a result of the inclined plane, depending on the angle thereof. In the case of a 45° variant, a 0.2 mm joint increases by a factor of 1/sin 45°=square root of 2=1.414.

FIG. 4 shows an exploded view of the coated workpiece of FIG. 2. The coating material 10 is shown on the right-hand side of FIG. 4. As is clear to see from FIG. 4, the recess 10a in the coating material 10 of the second embodiment is formed such that it does not extend as far as the longitudinal sides of the coating material 10. This means that a predefined distance A is maintained between the two longitudinal sides of the coating material 10 and the recess 10a. Moreover, the recess 10a has an equal-sided trapezoidal form which tapers inward, i.e. into the coating material 10. Accordingly, the recess has a long base side G arranged on the surface 01 of the coating material 10 which later comes into contact with the workpiece W, in particular with the surface or workpiece side W1. The depth T of the coating material 10 is selected such that it is smaller than a thickness D of the coating material. As already stated above, the shape of the recess 10a and that of the profile P that is complementary thereto can be freely selected, with combinations of straight lines, chamfers and arcs being conceivable. In the case of both shapes it should just be ensured that when coating the workpiece W the profile P of the workpiece W can be inserted into the recess 10a in the coating material 10 and preferably that the contact surface between the recess 10a and the profile P is maximized.

As can also be derived from FIG. 4, the workpiece W has on the surface or workpiece side W1 a profile P which is complementary at least in part to the recess 10a in the coating material 10. Complementary at least in part is to be understood here to mean that the profile P is formed such that it can definitely be inserted into the recess 10a, i.e. its dimensions are smaller than those of the recess 10a. On the other hand, however, the profile P should not be so small that large spaces are formed between the profile P and the recess 10a. In the second embodiment shown, the profile P has the form of a trapezoidal protrusion 13. As can also be derived from FIG. 4, owing to the trapezoidal form of the recess 10a/protrusion 13 the connecting area (contact surface) between the coating material 10 and the workpiece W is larger, which increases the strength of the connection and reduces the risk of the coating material 10 (on the edge) peeling away from the workpiece W.

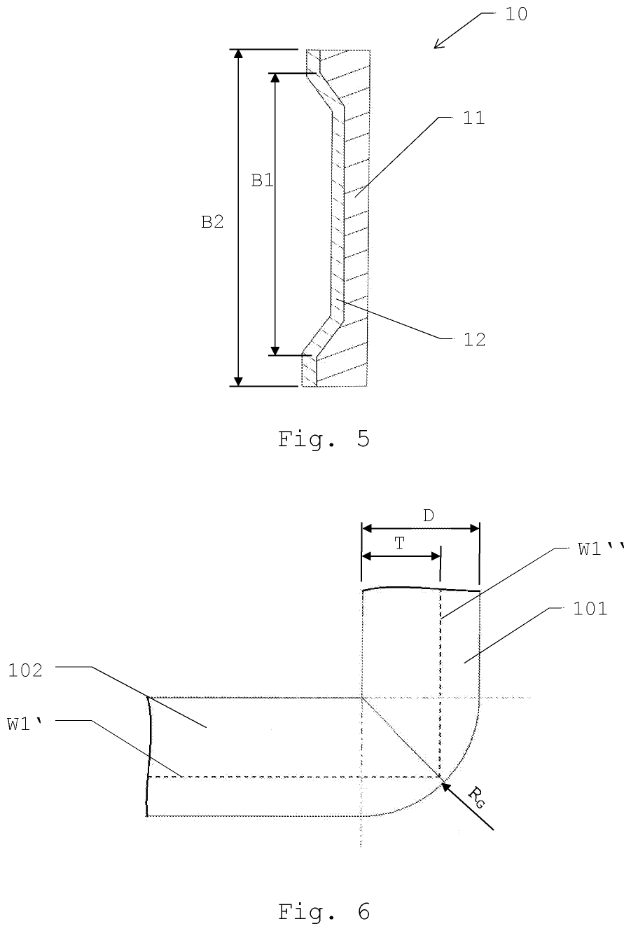

FIG. 5 merely shows a coating material 10, wherein the coating material 10 consists of a supporting layer 11 and an adhesive layer 10. As is also revealed by FIG. 5, the adhesive layer 10 is provided on the side of the coating material 10 on which the recess 10a is formed in the coating material 10. FIG. 5 also illustrates the fact that a width B1 of the recess 10a, which corresponds to a maximum width of the recess 10a, is smaller than a width B2 of the coating material 10.

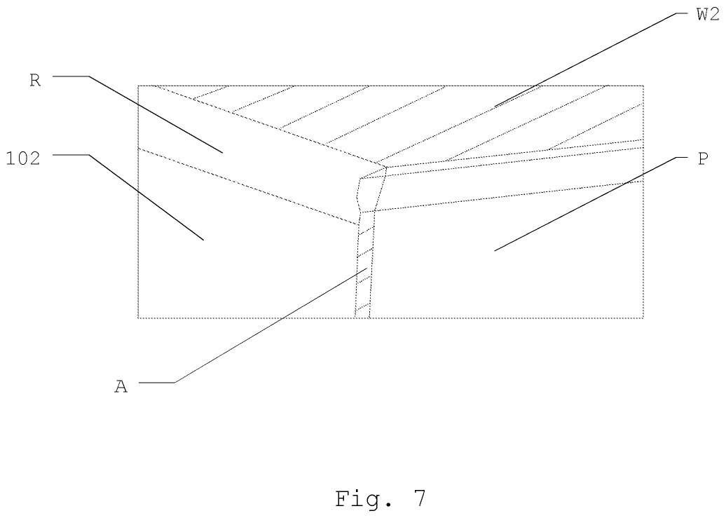

FIG. 6 schematically shows a connecting corner of a workpiece which has been coated in accordance with the coating method shown in FIG. 2. As can be seen from FIG. 6, two coating materials 10 meet in the connecting corner shown, wherein the two coating materials 10 are a longitudinal coating 102 and a transverse coating 101. The connecting corner comprises a longitudinal side (surface) W1′ and a transverse side W1″ of the workpiece W, which are disposed at right angles to one another.

The corner can be machined using methods that are nowadays customary. Only the additional profiling of the narrow side(s) is necessary. First, the longitudinal side of the workpiece is provided with chamfers; then the longitudinal coating 102 is applied to the longitudinal side W1 and after that the overhang of the longitudinal coating 102 is cut back. In the next step, a finishing process is carried out on the longitudinal side (profile+surface). Subsequently, the transverse side W1″ (including the longitudinal side that has already been glued on) is provided with chamfers and the transverse coating 101 is applied to the transverse side W1″. After that, the overhang of the transverse coating 101 is cut back and form milling is performed on the radius R_{G}. Finally, a finishing process is carried out on the transverse side (profile+surface).

In this regard the two recesses 10a in the two coating materials 101, 102 have the same depth T, which is selected such that the coating materials 101, 102 completely surround the workpiece W, in particular the connecting corner of the workpiece W. In other words, the depth T of the two recesses 10a is selected such that the depth T is smaller than a miter radius R_{G} of the two coating materials 101, 102.

FIG. 7 schematically shows a spatial representation of a connecting corner of a workpiece which has been coated in accordance with the coating method shown in FIG. 3, wherein, as is described above, only the longitudinal side W1′ of the workpiece W has so far been provided with the longitudinal coating 102, the longitudinal coating 102 has been cut back and on the transverse side W1′ the profile P has been milled. As can be seen from FIG. 7, after the transverse side W1 has been profiled a bearing surface A or contact surface is formed on the longitudinal coating 102, and since on account of the profiling this is smaller than in the case of conventional coatings, the strength of the coating in the corner region is improved.

1. A method for coating a surface, in particular a narrow side of a plate-shaped workpiece which consists, at least in part, of wood, wood-based materials, wood substitute materials, plastics material or the like, comprising the steps of:
supplying a coating material, wherein the coating material has a recess extending in the longitudinal direction of the coating material, and
applying the coating material to at least one surface of a workpiece to be coated,
wherein the workpiece has, on the surface thereof, a profile which is complementary at least in part to the recess in the coating material.

2. The method according to claim 1, further comprising:
a machining process, by means of which the profile of the workpiece is formed, wherein the machining process is carried out using a milling tool, a scraping tool and/or an abrasive belt.

3. The method according to claim 1, wherein the profile is formed on the at least one surface to be coated of the workpiece while the workpiece is supplied and while the coating material is applied to the workpiece and it has already been formed thereon in a previous work step.

4. The method according to claim 1, wherein scanning is performed on the workpiece to be coated, in particular thickness scanning and/or contour scanning, while the profile is formed on the at least one surface to be coated of the workpiece.

5. The method according to one of claim 1, wherein the recess extending in the longitudinal direction of the coating material is formed while the coating material is produced.

6. The method according to claim 1, wherein the recess in the coating material is formed by way of machining during the extrusion of the coating material, in particular the co-extrusion of the supporting layer and the adhesive layer, and/or after the extrusion of the coating material.

7. The method according to claim 1, wherein a trapezoidal protrusion that is complementary at least in part in particular to the recess in the coating material is milled on the at least one surface to be coated using at least one profile milling tool, while the workpiece to be coated is supplied.

8. The method according to claim 1, wherein an adhesive/functional layer is applied at least in sections to the surface to be coated of the workpiece and/or to the surface of the coating material provided with the recess, wherein the adhesive/functional layer is applied to the coating material by means of aftercoating while the coating material is produced and it is subsequently applied to the profiled coating material and the profiled workpiece.

9. The method according to claim 1, wherein the activation of an adhesive layer of the coating material is carried out during a relative movement between the coating material and the workpiece, wherein the activation is carried out by way of an energy source selected in particular from a laser, a hot air source, a gassing source, an infrared source, an ultrasound source, a magnetic field source, a microwave source, a plasma source or a LED source.

10. The method according to claim 1, wherein a connecting corner of the workpiece is coated using two coating materials, in particular using a longitudinal coating and a transverse coating, wherein the connecting corner has as its surfaces a longitudinal side and a transverse side, which are disposed at right angles to one another,
the two coating materials have a complementary chamfer in the connecting corner of the workpiece such that they abut against one another without raising the profile, and the depth of the recesses in the two coating materials is selected such that the coating materials completely surround the workpiece at the connecting corner thereof.

11. A coating material, in particular a narrow surface coating material, for coating a surface of a workpiece which consists, at least in sections, of wood, wood-based materials, wood substitute materials, plastics material or the like, comprising:
a supporting layer having a first surface, which is designed to be applied to at least one surface of a workpiece to be coated, and
a recess extending in the longitudinal direction of the coating material, wherein the recess is provided in the first surface.

12. The coating material according to claim 11, wherein when the coating material [[(10)]] is viewed in cross section, the recess is formed in a trapezoidal shape, a U shape, a V shape or a W shape or from a combination of chamfers, straight lines and arcs, wherein the recess has an equal-sided trapezoidal form with a longer base side (G) on the outer side of the coating material.

13. The coating material according to claim 11, wherein the recess is positioned and formed such that the longest dimension of the recess touches the two longitudinal side walls of the coating material or such that the longest dimension of the recess is a specified distance (A) from the two longitudinal side walls.

14. The coating material according to claim 11, wherein a depth (T) of the recess is selected such that the depth (T) is smaller than a miter radius (R_{G}) or a miter angle at at least one end of the coating material.

15. The coating material according to claim 11, further comprising an activatable or reactivatable adhesive layer.

16. The coating material according to claim 11, which is a co-extruded coating material, wherein in particular the supporting layer and the adhesive layer are co-extruded, or the supporting layer of the coating material is provided with an adhesive layer following the production thereof, wherein the adhesive layer is applied using nozzles or profiled paste rollers.

17. The coating material according to claim 11, wherein the supporting layer of the coating material is formed at least in sections of PVC, polystyrene, in particular of ABS, of PP, PE, polycarbonate and/or polymethylmethacrylate (PMMA), as HPL, CPL, melamine paper and/or as a veneer.

18. The coating material according to claim 11, wherein the coating material has a thickness (D) of between 0.5 mm and 4 mm, wherein the adhesive layer in particular has a thickness of 0.1 mm to 0.3 mm and the recess has a depth (T) of 0.1 mm to 3 mm.

19. The coating material according to claim 11, wherein the adhesive layer of the coating material has color pigments.
